(19) United States
(12) Patent Application Publication
(10) Pub. No.: US 2007/0252891 A1
(43) Pub. Date: Nov. 1, 2007

(54) System and Method for Interacting Wirelessly with Digital Signage

(75) Inventor: Steven L. Gurley, Plano, TX (US)

Correspondence Address: BAKER BOTTS L.L.P., 2001 ROSS AVENUE, SUITE 600, DALLAS, TX, 75201-2980, US

(73) Assignee: Symon Communications, Inc., Plano, TX (US)

(21) Appl. No.: 11/740,618

(22) Filed: Apr. 26, 2007

Related U.S. Application Data
(60) Provisional application No. 60/745,797, filed on Apr. 27, 2006.

(51) Int. Cl. H04N 7/14

(52) U.S. Cl. 348/14.01

(57) ABSTRACT

According to one embodiment of the invention, a method allows user interaction with information presented on electronic video displays. The method provides content for presentation on at least one display in a venue. A text-based message is received, from a venue patron, from a wireless device. The text based message is based upon the content presented on the at least one display in the venue and includes information to modify the content on the at least one display. The text based message is processed and a communication is transmitted to the venue to modify the content on the at least one display or create a memento of the content on the at least one display.

### CROSS-REFERENCE TO RELATED APPLICATIONS

Pursuant to 35 U.S.C. § 119 (e), this application claims priority from U.S. Provisional Patent Application Ser. No. 60/745,797, entitled A SYSTEM AND METHOD FOR INTERACTING WIRELESSLY WITH DIGITAL SIGNAGE SYSTEMS, filed Apr. 27, 2006. U.S. Provisional Patent Application Ser. No. 60/745,797 is hereby incorporated by reference.

### TECHNICAL FIELD OF THE INVENTION

This invention relates generally to the field of audio/video content management systems for displaying content on electronic displays in public and private venues and, more particularly, to a system and method for interacting wirelessly with digital signage.

### BACKGROUND OF THE INVENTION

There is a growing trend in which electronic displays (e.g. LED, LCD or Plasma monitors) are being installed in public/private venues (e.g. bars, restaurants, stores, lobbies, cafeterias, etc.) for the purpose of presenting digital content that will entertain and inform venue patrons and visitors. This visual communications medium is commonly referred to as “digital signage.”

### SUMMARY OF THE INVENTION

According to one embodiment of the invention, a method allows user interaction with information presented on electronic video displays. The method provides content for presentation on at least one display in a venue. A text-based message is received, from a venue patron, from a wireless device. The text based message is based upon the content presented on the at least one display in the venue and includes information to modify the content on the at least one display. The text based message is processed and a communication is transmitted to the venue to modify the content on the at least one display or create a memento of the content on the at least one display.

Certain embodiments of the invention may provide numerous technical advantages. For example, a technical advantage of one embodiment may include the capability to allow digital signage viewers to establish a wireless connection with the digital signage systems in order to direct and influence the type of content that is displayed on one or more electronic video displays. Other technical advantages of other embodiments may include the capability to allow digital signage viewers to wirelessly interact with the digital signage systems in a way that enables the viewer to influence or change elements within the signage content, for example, colors, characters, information, and the like. Yet other technical advantages of other embodiments may include the capability to allow digital signage viewers to wirelessly interact with the digital signage systems in a two-way exchange of information that will be facilitated by the signage content. Still yet other technical advantages of other embodiments may include the capability to allow digital signage systems to collect information on viewer wireless interactions on a real-time basis and provide content creators/managers with data for gaining insight into the interactions. Still yet other technical advantages of other embodiments may include the capability to allow digital signage systems to provide real-time reporting on viewer interactions with the digital signage systems and content that will be easy to understand and interpret, for example, a dashboard. Still yet other technical advantages of other embodiments may include the capability to allow digital signage systems to provide viewers with a memento of the viewing experience by enabling the signage system to address and send information to peripheral devices, such as printers, based upon a viewer's request. Still yet other technical advantages of other embodiments may include the capability to allow digital signage systems to accommodate multiple viewers to wirelessly interact with the digital signage system in order to vote on or rank content, take part in surveys, play games, and the like.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 shows an embodiment of a general purpose computer that may be used in connection with one or more pieces of software and/or hardware employed by other embodiments of the invention;

FIG. 2 shows an example of a system that may be used with particular embodiments of the invention;

FIGS. 3A, 3B, and 3C depict steps associated with a wireless digital signage interaction, according to an embodiment of the invention;

FIG. 4 depicts an example generation of a request, message or transaction, according to an embodiment of the invention;

FIG. 5 depicts a process of generating a memento of a viewing experience, according to an embodiment of the invention;

FIG. 6 depicts a method of processing a wireless digital signage interaction request, according to an embodiment of the invention; and

FIG. 7 depicts a graphical representation of performance reporting, according to an embodiment of the invention.

### DETAILED DESCRIPTION OF EXAMPLE EMBODIMENTS OF THE INVENTION

It should be understood at the outset that although example embodiments of are illustrated below, other embodiments may be implemented using any number of techniques, whether currently known or in existence. The invention should in no way be limited to the example embodiments, drawings, and techniques illustrated below, including the embodiments and implementation illustrated and described herein. Additionally, the drawings are not necessarily drawn to scale.

The primary objective of digital signage is to deliver content that will engage viewers and entice them to change their behavior or take a specific action such as purchase an advertised product. There are, however, at least five major limitations of today's digital signage implementations:
1) The playlists (e.g. schedules) for delivering content to electronic video displays are constructed by those responsible for creating and/or managing the content; therefore, the effectiveness of the content to capture a viewer's attention is highly dependent on the content creator/manager's understanding of each viewer's needs and preferences at a given point in time. Since it is impossible to consistently predict the needs and preferences of large groups of viewers at various moments in time, the effectiveness of digital signage to engage the interest of viewers is sub-optimized.
2) Most digital signage implementations are passive experiences in which the content is presented on an electronic video display and the viewer is expected to passively watch. This puts added pressure on the content creators to craft a message that is sufficient to keep a viewer's attention and incite them to take a specific action. Given that interactive forms of media in today's economy, e.g. the Internet, video games, etc., are growing in use while passive forms of media, e.g. watching TV, reading newspapers and magazines, are declining in use, digital signage is less likely to engage viewers unless the experience is more interactive.
3) Digital signage deployments have no inherent ability to collect real-time data on viewer receptivity to a given message nor do they possess a mechanism to quickly ascertain a viewer's preference for one piece of content over another. As a result, content creators/managers lack timely and meaningful insight into which pieces of content they should emphasize and which they should deemphasize.
4) Digital signage systems have no mechanism to allow content creators/managers/owners to translate the raw data regarding a viewer's experience with the digital signage (if such data did exist) into real-time, easy to-understand and actionable information.
5) Digital signage applications assume that the viewer will observe the content and remember the message. Since it is unlikely that a viewer will remember a message unless they are in a position to act on it immediately, the effectiveness of the signage application is limited to a particular moment in time.

Accordingly, teachings of certain embodiments of the invention recognize a system and method that enhances the viewing experience by allowing viewer to have a more personal, interactive experience with digital signage. According to teachings of certain embodiments, the system and method allows content creators/managers to have real-time insight into viewer interactions. According to teachings of certain embodiments, the system and method allows viewers to viewers to remember the interaction far beyond the initial point of contact.

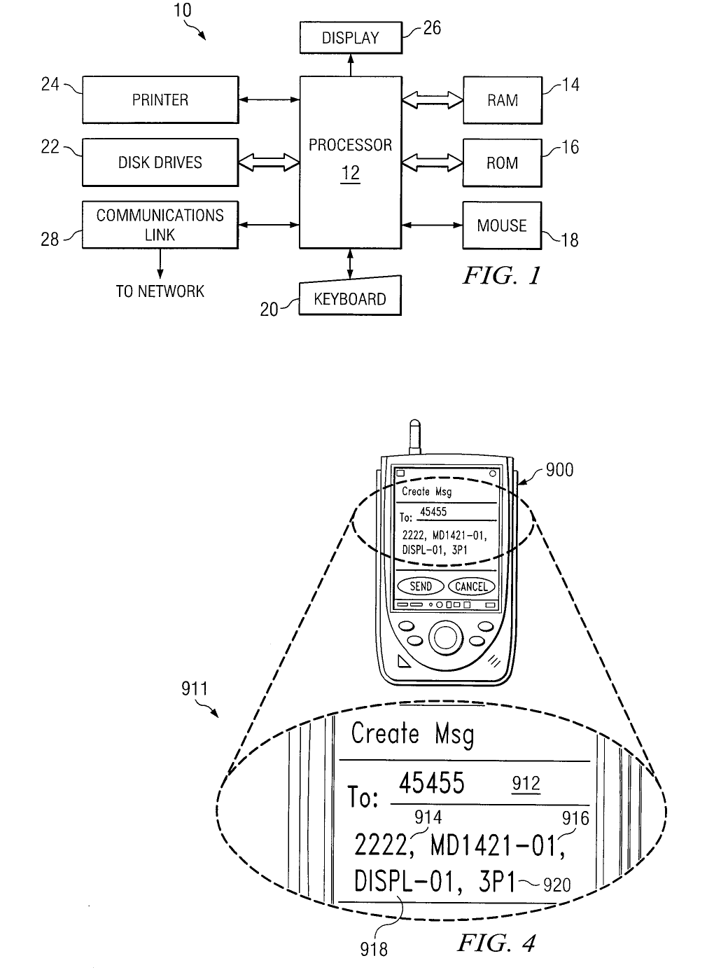

FIG. 1 shows an embodiment of a general purpose computer 10 that may be used in connection with one or more pieces of software and/or hardware employed by other embodiments of the invention. General purpose computer 10 may be adapted to execute any of the well-known OS2, UNIX, Mac-OS, Linux, and Windows Operating Systems or other operating systems. The general purpose computer 10 in the embodiment of FIG. 1 comprises a processor 12, a random access memory (RAM) 14, a read only memory (ROM) 16, a mouse 18, a keyboard 20 and input/output devices such as a printer 24, disk drives 22, a display 26 and a communications link 28. In other embodiments, the general purpose computer 10 may include more, fewer, or other component parts.

Embodiments of the present invention may include programs that may be stored in the RAM 14, the ROM 16, disk drives 22, or other suitable memory and may be executed by the processor 12. The communications link 28 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; radio communications; a satellite network; an enterprise intranet; other suitable communication links; or any combination of the preceding. Disk drives 22 may include a variety of types of storage media such as, for example, floppy disk drives, hard disk drives, CD ROM drives, DVD ROM drives, magnetic tape drives or other suitable storage media. Although this embodiment employs a plurality of disk drives 22, a single disk drive 22 may be used without departing from the scope of the invention.

Although FIG. 1 provides one embodiment of a computer that may be used with other embodiments of the invention, other embodiments of a computer may additionally utilize computers other than general purpose computers as well as general purpose computers without conventional operating systems. Additionally, embodiments of the invention may also employ multiple general purpose computers 10 or other computers networked together in a computer network. Most commonly, multiple general purpose computers 10 or other computers may be networked through the Internet and/or in a client/server network. Embodiments of the invention may also be used with a combination of separate computer networks each linked together by a private or a public network.

Several embodiments of the invention may include logic contained within a computer-readable medium. In the embodiment of FIG. 1, the logic comprises computer software executable on the general purpose computer 10. The medium may include the RAM 14, the ROM 16 or the disk drives 22. In other embodiments, the logic may be contained within hardware configuration or a combination of software and hardware configurations. The logic may also be embedded within any other suitable medium without departing from the scope of the invention.

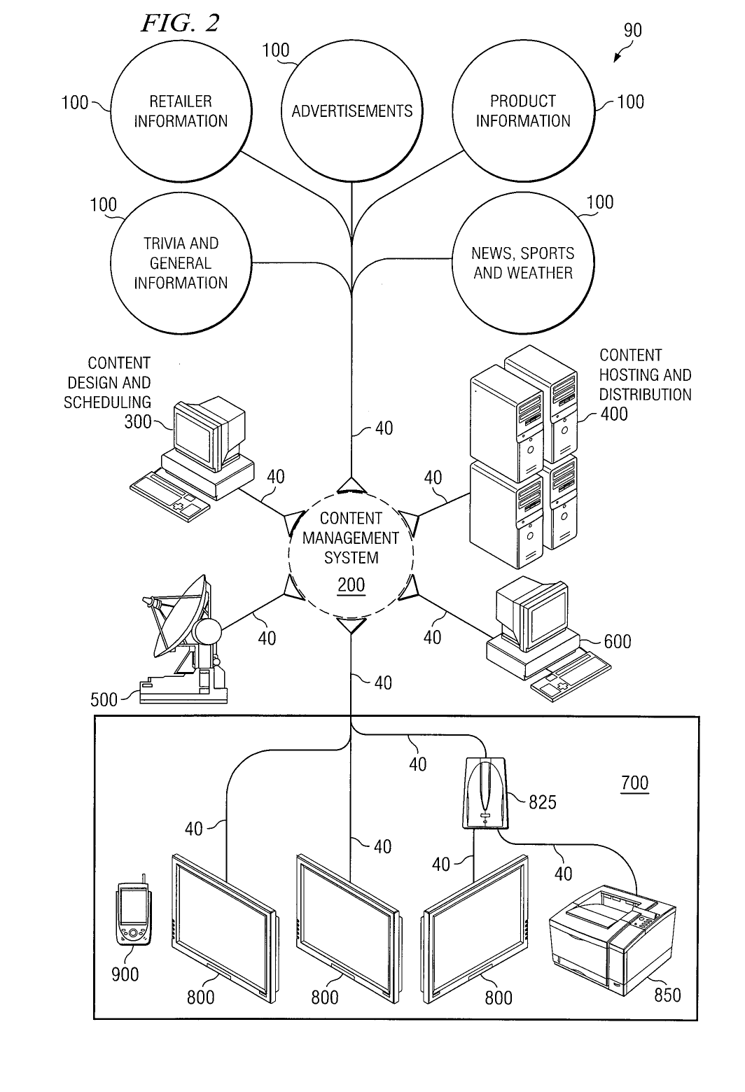

FIG. 2 shows an example of a system 90 that may be used with particular embodiments of the invention. Some, none, or all of the components of the system 90 or the system 90, itself, may use some, none, or all of the components of FIG. 1. The system 90 in particular embodiments may be used to display content on electronic video displays (digital signage) disposed in public and private venues. The system 90 of FIG. 2 in this embodiment includes communication links 40, content 100, a content management system 200, and a venue 700 with video displays 800.

The communication links 40 facilitate communication among the various components of the system 90. The communication links 40, may comprise all or a portion of a public switched telephone network (PSTN); a public or private data network; a local area network (LAN); a metropolitan area network (MAN); a wide area network (WAN); a global computer network such as the Internet; a wireline or wireless network; a local, regional, or global communication network; a satellite network; an enterprise intranet; other suitable communication links; or any combination of the preceding. In some embodiments, the communication links 40 may communication digital information between the components of the system 90 in the form of packets. Additionally, in particular embodiments the communication links (wired or wireless) may deliver content to electronic video displays 800. In delivering this content, the communication links 40 may include video player or video controller.

One or more content sources in particular embodiments provide content 100 for presentation on video displays 800 in the venues 700. The content 100 provided by these content sources may include, but is not limited to, advertisements, product information, news information, sports information, weather information, retail information, trivia information, general information, movie trailers, and the like. The content sources may include, but are not limited to, advertisers, product companies, venue owners, and the like. In particular embodiments, the content 100 is channeled into the content management system 200 using communications links 40. For example, in some embodiments, the content may be transferred to the content management system 200 by way of a digital network or by manual transfer from a physical storage medium.

The venues 700 may include any of a variety of locations operable to host video display(s) 800. Upon receiving the content 100 from the content management system 200, the video display(s) become digital signage. Examples of venues 700 include, but are not limited to restaurants, stores, airports, airplanes, train stations, trains, clubs, cruise liners, bars, hotels, employee break rooms, contact centers, cafeterias, concert halls, convention centers, stadiums, building lobbies, elevators, cab stands, and the like. In particular embodiments, the system 90 may take advantage of an existing communication infrastructure existing at particular venues 700 as part of the communication links 40. For example, particular venues 700 may have established wired (e.g., Ethernet LAN, video, or other wired technology) or wireless (e.g., wireless “hot spots”, 802.11 access points or other wireless communications) access.

The video displays 800 may comprise any of variety of platforms upon which digital signage content may be displayed to patrons of the venue 700. The digital signage content displayed on video displays 800 may include, but is not limited to, content 100 from content providers. Each venue 700 may have one or more video displays 800 installed. The displays 800 may be mounted inside the venue 700, outside the venue 700 or combinations thereof. In particular embodiments, the displays 800 may be electronic video displays. In such embodiments, the electronic video displays may comprise any video display technology capable of projecting dynamic and static video images, graphics, or any other items suitable for a particular venue 700. Examples of electronic video display technologies include, but are not limited to, CRT, DLP, LCD, LED, and Plasma technologies implemented on a television, a monitor, or a projector. In particular embodiments the displays 800 may support wired network connections or wireless network connections.

In particular embodiments, the venue 700 may include network connections 825, which facilitate the communication with peripheral devices 850 such as printers. As described in further details below, the peripheral devices 850 in particular embodiments may allow content viewers to create a memento of a digital signage encounter.

In routing the content to the various displays 700, the system 90 may include a variety of networks interface. For example, the architecture may utilize a switch for connecting the various local-area network components, (e.g. wired ETHERNET connections to the video controller and a wireless access point) and an IP Router for connecting a local-area network of the venue 700 to the communication link 40. In other embodiments, the system 90 may utilize other components.

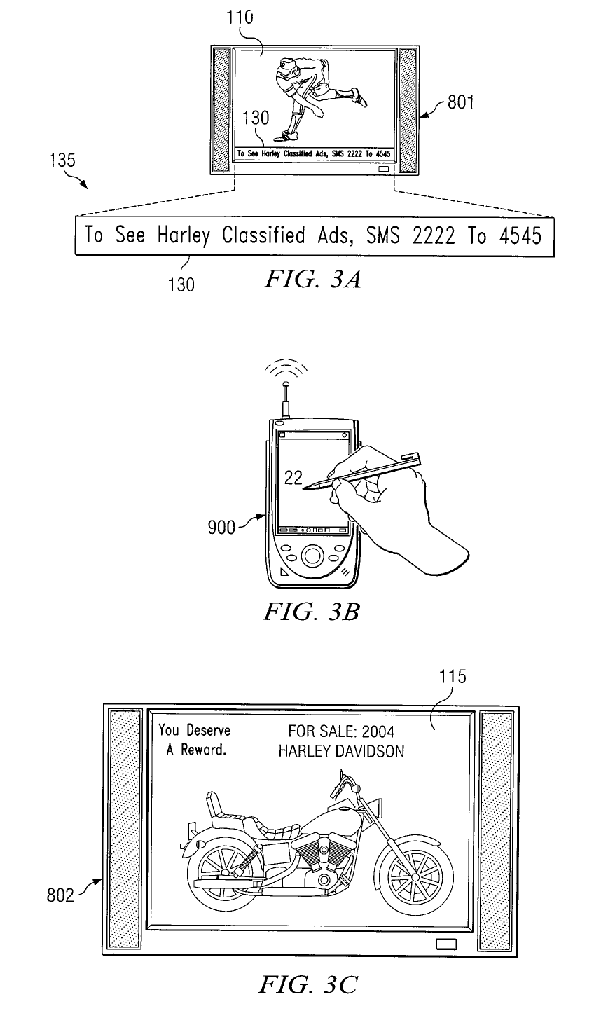

To facilitate an interaction with the video displays 800 in particular embodiments, content viewers at the venue 700 may utilize a communication device such as a wireless device 900 to communication information in the form of a request message, or transaction to the content management system 200 using communication link 40 and/or wireless communication network 500. Further details of this interaction are described below with reference to FIGS. 3A, 3B, 3C, 4, 5, and 7.

In particular embodiments, the information contained in the message or request may be information that is displayed on the video display 800. The information communicated to the content management system 200 may ultimately yield a change on a particular video displays 800 and/or cause a peripheral device 850 to respond. Example communications from wireless devices 900 include, but are not limited to two-way text communication features such as Short Messaging Services (SMS), wireless email, and the like.

The content management system 200 is responsible for hosting the software layouts, developing playlists (schedules), establishing and enforcing wireless interaction rules, processing incoming and outgoing wireless interactions and enabling performance reporting. In particular embodiments, the content management system 200 hosts an interface 300 (which in particular embodiments may be a web interface) that allows content creators/managers to, among other things, design content, create playlists (schedules), assign viewer interaction rules, and define reporting.

In particular embodiments, the content management system 200 may store content 100 from content sources, schedules, interaction rules, processing logic, and other items on one or more content server 400.

In particular embodiments, the content management system 200 hosts one or more connections to a wireless communications network 500 for the purpose of receiving and responding to user transactions.

In particular embodiments, the content management system 200 hosts an interface 600 (which in particular embodiments may be a web interface) that allows venue owners, content owners, and content creators/managers to access viewer interaction statistics and other information. Additionally, in particular embodiments, the content management system 200 hosts network connections (e.g., via communications link 40) to one of more venues 700 for the purpose of distributing content 100 from content sources to the electronic video displays 800.

In particular embodiments, the content management system 200 may engage in some, none, or all of the following functions:
a. Managing the creation and/or execution of playlists for scheduling the distribution of content 100 to one or more video display(s) 800;
b. Defining the rules by which the content management system 200 will process viewer interactions;
c. Establishing and maintaining a connection with one or more wireless communications network(s) 500 and/or communication links 40 for the purpose of collecting viewer interactions created on wireless communications devices 900;
d. Collecting interactions created on viewer's wireless communications devices 900 for the purpose of altering content, altering the play list, providing viewer reporting, polling, etc.;
e. Processing the viewer interactions into specific actions in accordance with viewer interaction rules for the purpose of directing processing functions and priorities;
f. Responding to one or more content viewer(s) for the purpose of confirming an interaction, requesting more information, soliciting an additional response, engaging in an interactive two-way session, and the like.
g. Collecting operational statistics on interaction transaction activity and viewer responses for the purpose of providing management reporting on both operational activity and viewer preferences.
h. Providing a web interface for use in:

1. Viewing operational statistics and interaction activity;

2. Defining and managing interaction reporting criteria; and

3. Defining and managing viewer interaction rules.

Particular embodiments of the system 90 may utilize components to engage in some, none, or all of the details of the following functions: a management function, a processing function, and a usage function. Further details of each are described below.

### The Management Function

The management function generally includes the process of defining and managing playlists (schedules), viewer interaction rules, processing logic, and the like. In particular embodiments, content creators/managers may use the content management system 200 to create one or more content play lists. In particular embodiments, the playlist(s) define the content/screen layouts that will play on one or more designated video displays 800 in accordance with an applicable program schedule. The program schedule in particular embodiments may define the date, time and duration that one or more pieces of content or screen layouts can play.

For each piece of content or layout within a given program schedule, the content creators/managers may also define viewer rules of interaction. Below are three example parameters of viewer rules of interaction, according to a particular embodiment:

A transaction code may define the processing logic associated with a given viewer interaction. For example, transaction code #123 may direct the content management system 200 to switch the content/layout that is seen by the viewer, while transaction code #456 may activate processing logic that directs a copy of the screen or related content to a peripheral device 850 such as a printer.

A sequence code may define the sequence in which transaction codes will be processed for a given piece of content or screen layout. Example sequence codes include the following:
a. First In, First Processed: each transaction code is processed in the order in which it is received.
b. Most Requested: transaction codes are queued and the most requested transaction codes will be placed first in queue.
c. Same Viewer: Process each interaction (transaction) for the same viewer until no more transactions for that viewer are received

A duration code may define the amount of time that transpires before the next transaction code affecting the content is processed. Example duration codes include the following:
a. Until Next Transaction Received: This code instructs the content management system 200 to play the content/layout until the next viewer interaction (transaction code) is processed.
b. Until Finished: This code instructs the content management system 200 to play the content/layout for the full duration stipulated in the playlist.
c. Until X Seconds: This code instructs the content management system 200 to play the content/layout for a designated number of seconds or until the end of the content/layout's duration as defined in the playlist's schedule, whichever occurs first.

### The Processing Function:

The processing function generally includes the process of executing viewer interaction transactions and reporting interaction statistics and other related data. The content management system 200, or components thereof, interfaces with one or more wireless networks, for example, communication links 40 or wireless communication network 500. This interface allows the content management system 200 to capture viewer interaction transactions as they are sent by the viewer. The viewer interaction in particular embodiments is sent to the content management system 200 via wireless SMS short code, wireless email, or other wireless, text-based communications service.

As the playlists are executed, the content management system 200 monitors the wireless network for viewer interactions. As the content management system 200 receives transaction activity, the content management system 200 will process the transactions according to the viewer interaction rules and associated processing logic.

In particular embodiments, the content management system 200 collects information on each viewer interaction. These usage statistics are compiled and segregated according to reporting rules. In particular embodiments, the content management system 200 may report on viewer interactions by viewer, display, venue, transaction code, and the like. The content management system 200 may also allow content creators/managers to define the reporting rules and criteria.

### The Usage Function:

The processing function generally includes a process whereby the viewer interacts with the digital signage and creates interaction transactions. In particular embodiments, video displays 800 such as electronic video displays are disposed in public and/or private venues. Venue patrons or visitors (viewers) observe digital content presented on electronic video displays (digital signage). The viewer may be advised through static signage (e.g. posters, banners, placards, etc.) and/or via information presented on the digital signage that the digital content can be changed, modified and/or engaged as a part of a two-way dialog between the viewer and the digital signage. The viewers may also be supplied with instructions on how to create a digital signage related transaction and may be provided with a list of the available transaction codes.

The viewer may use the wireless devices 900 (e.g. cell phone, PDA) to create a transaction, message, or request (interaction) using the text messaging feature (e.g. SMS, email, etc.) of the wireless device 900. The viewer may create a text message that may specify, among other things, the transaction code, location/display identifier and other pertinent information as may be set forth in the usage instructions resident within the venue. The viewer will then send the message to the address specified in the instructions.

Following the submission of a transaction, the content management system 200 in particular embodiments may acknowledge receipt via a text message reply to the wireless device 900. The viewer's transaction will then be executed according to the digital signage's interaction rules, which may be administered by the content management system 200.

In particular embodiments, the content management system 200 may engage in queuing algorithm that resolves which digital signage content will be displayed when multiple transactions, message, or requests have been received. For example, a first message may be received for a first type of content; however, four subsequent messages received after the first message may request a second type of content. The content management system 200 may elevate the time to display the second type of content above the first type of content based on the number of requests for the second type of content.

In particular embodiments, the content management system 200 may also display content that the viewers vote on. For example, multiple content streams (e.g., sports games or the like) may be displayed on a screen. Viewers may then vote on which of the content streams the viewers would like to watch. In particular embodiments, these votes may be specific to a particular video display 800, using techniques described with reference to FIG. 4, described in further details below.

In particular embodiments, the content management system 200 may also inform viewers of the position of the viewer's request in the queue using either the video display 800 or the wireless device 900. When using the video display 800, a side bar may display a list of the upcoming content that will be displayed. When using the wireless device 900, the content management system 200 may send a message to the wireless device—for example, “your request content will be displayed in approximately 30 seconds” or “your requested content will be displayed next.”

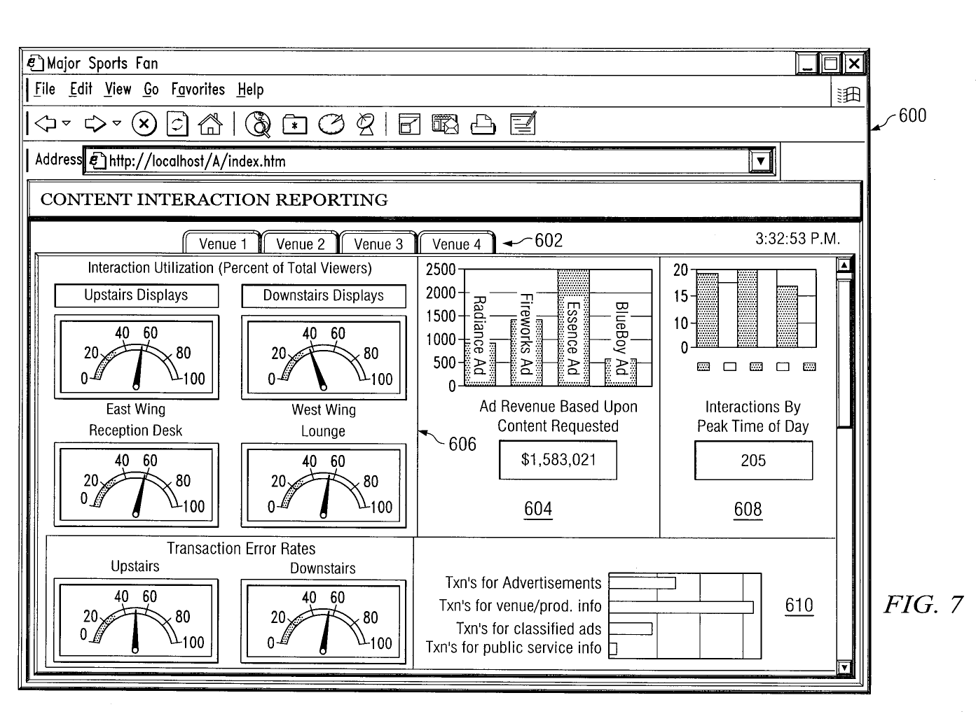

In particular embodiments, digital signage owners, venue owners, content owners and/or content creators/managers will have visibility into the transaction activity by way of a web interface and/or performance dashboard. This reporting feature will allow the interested parties to understand viewer interactions—both in terms of numbers of interactions and types of interactions. They will also be positioned to understand which pieces of content and screen layouts generated the most interest. Further details of an example dashboard are provided below with reference to the FIG. 7.

FIGS. 3A, 3B, and 3C depict steps associated with a wireless digital signage interaction, according to an embodiment of the invention. FIG. 3A illustrates an embodiment of an electronic video display 801 presenting content 110 prior to the viewer creating a transaction to interact with the signage. In this example, the content 110 on the electronic video display 801 is a product advertisement. In addition to the advertisement, the content 110 includes a ticker line 130 that provides viewers with scrolling instructions that describe the mechanism and processes that the viewer should employ to change the content 110 from a product advertisement to a classified listing. In other embodiments of the invention, the content type and corresponding changes that can be made to the content are limitless. For clarity purposes, an exploded view 135 of the ticker line 130 is provided.

FIG. 3B depicts a graphic of a viewer executing and transmitting a transaction to change the content 110 of FIG. 3A from a product advertisement to a classified ad listing. The viewer may enter the transaction code (shown), the location code of the venue or identifier of the electronic video display (not shown), and other related information on the wireless device 900 as the application may require. Further details are provided below with reference to FIG. 4.

FIG. 3C illustrates an embodiment of an electronic video display 802 that reflects the resulting change in content 115 from an advertisement to classified listing following execution of the viewer interaction by the content management system 200.

FIG. 4 depicts an example generation of a request, message or transaction, according to an embodiment of the invention. A viewer of digital signage (for example, content 110 on display 801 of FIG. 3A), upon viewing the display 801 may activate a messaging application of a wireless device 900. Exploded view 911 shows details of the generation of the request. The “To,” or addressee line 912, depicts a SMS short messaging addressee of “45455.” In particular embodiments, the SMS address code of 45455 may be used by the wireless network to route the transaction to the digital signage's content management 200 system for processing.

The line following the line of the addressee 912 is the transaction detail line. The transaction detail line may be composed of one or more elements that control the processing logic of the transaction management system 200. In this example, there are four elements and the first element of the detail line is a four-digit transaction code 914 that will be used by the content management system 200 to determine the method and logic by which the transaction will be processed. In particular embodiments, this is all that may be transmitted by the wireless device 900. In other embodiments, more information may be transmitted.

The second element of the detail line is a venue location designator 916. The location designator 916 may used by the content management system 200 to identify the appropriate playlist or display currently running for an appropriate venue. A display designator can be found to the right of the hyphen in the location designator 916. The display designator allows a viewer to interact with the content of a specific display disposed in a venue that contains multiple displays. The display indicator 917 may also used by the content management system 200 to further match the transaction to the appropriate playlist.

The third element of the detail line is a transaction object 918. The transaction object 918 is dependent on the transaction code 914. This element provides the content management system 200 with insight into what actions should be taken for the given transaction code. Referring to the example depicted in FIGS. 3A, 3B, and 3C, the viewer chose to change the digital signage content from an advertisement to a classified listing. In that example, the transaction code of 2222 instructed the content management system 200 to change the content being displayed. The transaction object 918 as depicted in FIG. 4 further instructs the content management system 200 to change the content being displayed to a classified listing. The element to the right of the hyphen in the transaction object 918 provides direction to the content management system 200 to use the classified listing for a Harley Davidson.

The forth element of the detail line is a venue key 920. The venue key 920 is a random code presented on the digital signage that changes every few minutes. The venue key 920 is based on an algorithm that uses the time of day and location of the venue to create a unique identifier. This identifier may used by the content management system 200 to ensure that the viewer is actually present in the venue when executing the transaction. This feature limits hackers from a remote location randomly changing or modifying the content.

The format of each viewer interaction transaction may be determined by those who administer the content management system. The viewers will be provided information via static signage (e.g. posters, placards, table tents, etc) or via the digital content as to what transaction may be allowable for a given venue.

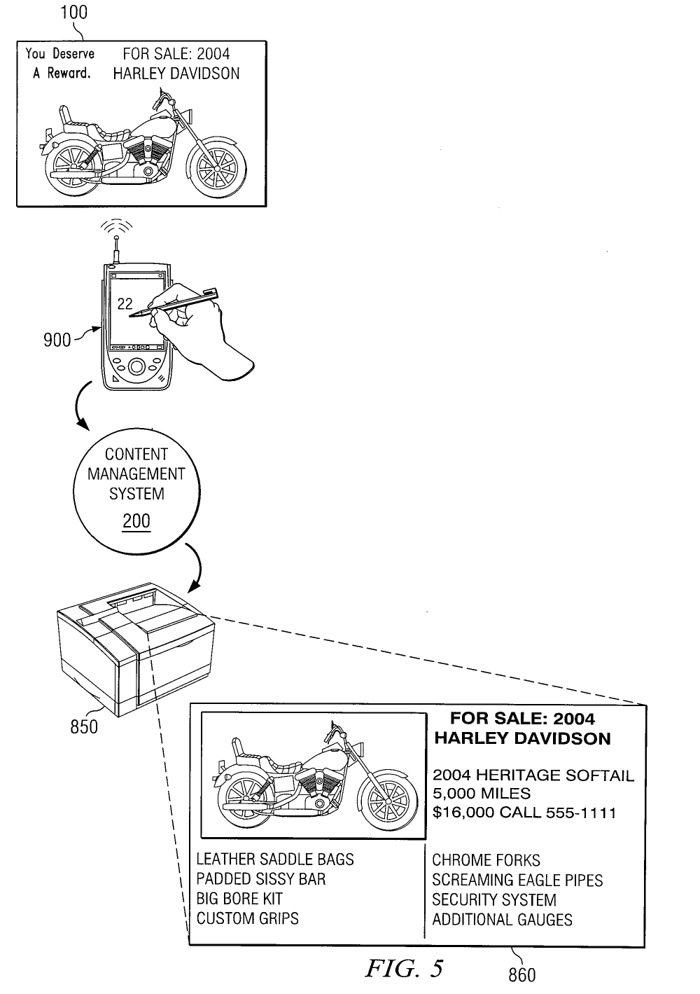

FIG. 5 depicts a process of generating a memento of a viewing experience, according to an embodiment of the invention. Current digital signage deployments provide no mechanism for viewers to remember their interaction with the signage content. These implementations assume that the viewer will respond to the message upon viewing or soon thereafter. Since this is not always the case, the viewer has no way to remember the message or the experience beyond the initial point of contact. Accordingly, viewers may utilize components of the system 90 of FIG. 1 to create a memento of the experience.

As shown in FIG. 5, a viewer upon seeing the content 100 advertising a Harley Davidson, executes a wireless transaction with wireless device 900 to create a memento. The transaction is processed by the content management system 200, which then sends a memento of the content 100 to a nearby peripheral device 850 such as a printer. The peripheral device 850 such as a printer then prints the memento 860 that the Viewer can then take home to act upon at a later time.

Other embodiments of this invention may direct the memento to other peripheral devices 850 or other devices. For example, in one embodiment, the memento may be sent to the user's wireless device 900. As one example, a user may email a message to an address shown upon a video display 800 and receive a responsive email or text message with a memento of the viewing experience. In both of the above scenarios, a viewer takes information about the content 100 with them.

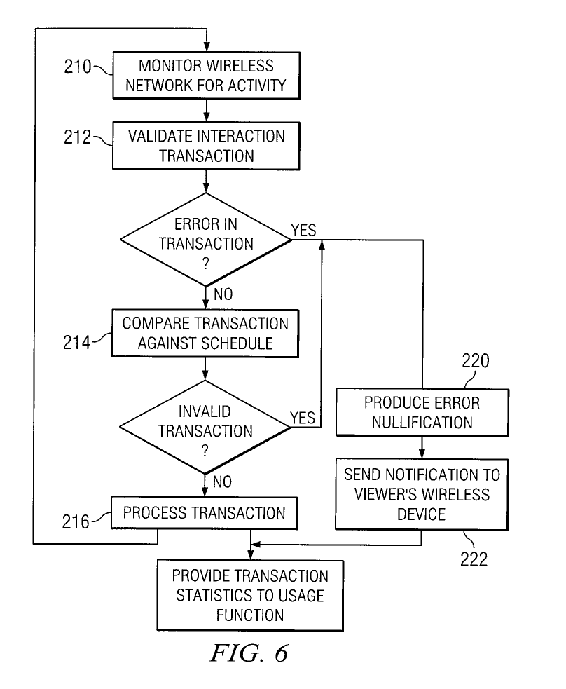

FIG. 6 depicts a method 205 of processing a wireless digital signage interaction request, according to an embodiment of the invention. In particular embodiments, the method 200 may be carried out by hardware and/or software associated with the content management system 200. The hardware and/or software in particular embodiments may include components of FIG. 1.

The method 205 begins with a process 210 of monitoring a wireless network for activity. Process 210 may include monitoring the communication link 40 and/or wireless communication network 500 for viewer interaction transactions. Process 210 may also include a mechanism to monitor content repositories provided by third-parties who monitor and collect information from communication links or wireless communication networks. As transactions are received, the transactions, messages, or requests are extracted from the network and/or content repository and then passed to a validation process 212. The validation process 212 analyzes the transaction to determine if the transaction code in the transaction is present and valid. The validation process 212 may also analyze the balance of the transaction to determine if it is in the right format for the given transaction code. The validation process 212 may also inspect the accompanying transaction parameters to determine if they are valid for that particular transaction code. At decisional process 213, if anything from the validation process 212 is in error, the yes branch is followed and the content management system creates an error response at process 220 and sends a notification to the viewer's wireless device at process 222 so that the viewer may make the necessary changes. If there are no errors at decisional process 213, the no branch is followed towards a schedule verification process 214.

The schedule verification process 214 compares the transaction and accompanying transaction code against the content or screen layout schedule currently running for the display or venue location specified in the transaction. The schedule verification function 214 may also determine if the transaction code is valid for the content or screen layout currently being played. At decisional process 215, if anything from the schedule verification process 214 is in error, the yes branch is followed and the content management system create an error response at process 220 and sends a notification to the to the viewer's wireless device at process 222 so that the viewer may make the necessary changes. If there are no errors at decisional process 215, the no branch is followed towards processing of the transaction at process 216.

Once authorized to execute, the transaction processing process 216 will execute the processing logic for the requested transaction code. The processing logic will use the parameters extracted from the transaction record to consummate the function requested of the transaction. The process will repeat for each transaction in the queue of pending transactions.

For each step in the process function, the content management system 200 compiles a repository of statistics. These statistics may include, but are not be limited to, the number of incoming transactions, the number of transactions with validation errors, the transaction by transaction code, the number of error messages sent to viewers, and the like. These statistics are compiled at a process 218 for subsequent use in the usage function of the content management system 200.

FIG. 7 depicts a graphical representation of performance reporting, according to an embodiment of the invention. In particular embodiments, the reporting may be real-time interaction reporting. In particular embodiments, such an interaction reporting feature will allow content creators, managers, venue owners, advertisers, and the like to have immediate or near-immediate insight into viewer interactions with the digital signage and the types of content that the viewers are requesting.

In the embodiment of interaction reporting of FIG. 7, a web based performance dashboard 600 is shown. In other embodiments, other forms of performance reporting may be utilized. Additionally, in other embodiments, other performance metrics may be reported.

In the embodiment of FIG. 7, each venue in which digital signage is deployed is represented by a separate tab 602 on the dashboard 600. Some embodiments may provide summary reporting on all venues, while other embodiments may provide reporting by region. Certain embodiments may also allow the content creators/managers to decide how venues will be aggregated and reported.

Many digital signage owners receive advertising revenue from ad content that is presented on their electronic video displays. The corresponding advertising revenue may be tied to the numbers of viewers who see the ads. However, current digital signage deployments have no mechanism for measuring actual viewership. For example, advertisers may pay a set fee for every X number of customers that enter the venue.

To mitigate the above undesirable circumstance, certain embodiments may allow advertisers to understand the number of viewers that request certain types of content. Additionally, certain embodiments may enable advertisers to understand how their ad compares in relation to other ads shown on the same digital signage.

The graphic of FIG. 7 depicts a bar chart 604 showing the level of demand that four advertisements generated. The bar chart 604 additionally gives the digital signage owner an accounting of the amount of advertising dollars that are being earned based upon viewer demand as measured by the number of interactions.

Other metrics that may be important to content creators, managers, advertisers, and venue owners, include, but are not limited to, utilization statistics 606, interactions during peak periods of the day 608, and interactions by type of content 610.

In particular embodiments, the reporting feature may be useful in helping content creators and mangers refine the type, format and schedules in which content is delivered.

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

What is claimed is:

1. A method of allowing user interaction with information presented on electronic video displays, the method comprising:
providing content for presentation on at least one display in a venue;
receiving, from a venue patron, a text-based message from a wireless device, the text-based message based upon the content presented on the at least one display in the venue;
processing the text-based message; and
transmitting a communication to the venue in response to the text-based message.

2. The method of claim 1, wherein the communication to the venue modifies the content on the at least one display.

3. The method of claim 2, wherein the communication is specific to the at least one display.

4. The method of claim 2, wherein the communication includes content requested by the text-based message.

5. The method of claim 1, wherein the communication to the venue creates a memento of the content on the at least one display for the venue patron.

6. The method of claim 5, wherein the memento is a printout from a printer located at the venue.

7. The method of claim 5, wherein
the communication is a memento message to the wireless device with the memento, and
the memento is stored in memory on the wireless device.

8. The method of claim 1, wherein receiving, processing, and transmitting are carried out by a content management system remote from the venue.

9. The method of claim 1, wherein
the content on the at least one display is presented in accordance with a schedule; and
the communication to the venue modifies the schedule.

10. The method of claim 1, wherein the text-based message is a Short Messaging Service (SMS) message.

11. The method of claim 1, wherein the text-based message is a wireless email.

12. The method of claim 1, wherein the text-based message includes a code specific to the at least one display.

13. The method of claim 12, wherein the code distinguishes the at least one display from other displays.

14. The method of claim 1, wherein the text-based message includes a venue key that is displayed on the at least one display in the venue, the venue key changing over time.

15. The method of claim 14, wherein the venue key changes over time based on an algorithm that uses a time of day and location of the venue to create the venue key.

16. The method of claim 1, further comprising:
receiving, from one or more venue patrons, a plurality of text-based messages from one or more wireless devices;
processing each of the plurality of text-based messages;
recording information obtained from the processing; and
reporting the information via an interface to a user.

17. The method of claim 16, wherein the interface is presented in a dashboard format and accessible via a web browser.

18. The method of claim 16, wherein the information includes a number of viewers that request certain types of content.

19. The method of claim 1, further comprising:
notifying the venue patron of a position in a queue for processing of the text-based message.

20. The method of claim 19, wherein the notification occurs on the at least one display in the venue.

21. The method of claim 19, wherein the notification is sent to the wireless device.

22. The method of claim 1, wherein processing the text-based message includes:
validating contents of the text-based message, and
if the text-based message is successfully validated, executing logic applicable to a request in the text-based message.

23. The method of claim 1, wherein processing the text-based message includes:
comparing a transaction code in the text-based message against a schedule currently running for the at least one display in the venue, and
if the transaction code is allowed, modifying the schedule.

24. The method of claim 1, wherein processing the text-based message includes preparing a solicitation of additional information from the venue patron, wherein the solicitation is transmitted to the wireless device.

25. The method of claim 1, wherein
a plurality of text based message are processed, and
the text-based messages are processed in accordance with viewer interaction rules.

26. The method of claim 25, wherein the viewer interaction rules include a consideration of processing the text-based messages in the order the text-based messages are received.

27. The method of claim 25, wherein the viewer interaction rules include a consideration of processing the most requested content first.

28. The method of claim 25, wherein the viewer interaction rules include a consideration of processing, for a given time period, all the text-based messages from the venue patron before processing text-based messages from other venue patrons.

29. The method of claim 25, wherein the viewer interaction rules prescribe displaying content requested in the text-based message until another text-based message is received.

30. The method of claim 25, wherein the viewer interaction rules are updatable by a system administrator.

31. The method of claim 25, further wherein the viewer interaction rules are updatable by a system administrator through a web interface.

32. A method of allowing user interaction with information presented on electronic video displays, the method comprising:
receiving, from a venue patron, a message from a device, the message based upon content presented on at least one display in a venue;
processing the message; and
transmitting a communication to the venue in response to the message, the communication creating a memento of content on the at least one display for the venue patron.

33. The method of claim 32, wherein the memento is a printout from a printer located at the venue.

34. The method of claim 32, wherein the device is a wireless device.

35. A method of allowing user interaction with information presented on electronic video displays, the method comprising:
receiving, from a venue patron, a message from a device, the message based upon content presented on at least one display in a venue;
processing the message; and
notifying the venue patron of a position in a queue for processing of the message.

36. The method of claim 35, wherein the notification occurs on the at least one display in the venue.

37. The method of claim 35, wherein the notification is sent to the device.

38. A method of allowing user interaction with information presented on electronic video displays, the method comprising
receiving, from one or more venue patrons, a plurality of messages from one or more devices; and
processing each of the plurality messages;
recording information obtained from the processing; and
reporting the information via a web interface to a user.

39. The method of claim 38, wherein the web interface is presented in a dashboard format.

40. The method of claim 38, wherein the information includes a number of viewers that request certain types of content.

41. A method of allowing user interaction with information presented on electronic video displays, the method comprising
receiving, from one or more venue patrons, a plurality of messages from one or more devices, the messages based upon content presented on at least one display in a venue; and
processing the messages in accordance with viewer interaction rules.

42. The method of claim 41, wherein the viewer interaction rules include a consideration of processing the text-based messages in the order the text-based messages are received.

43. The method of claim 41, wherein the viewer interaction rules include a consideration of processing the most requested content first.

44. The method of claim 41, wherein the viewer interaction rules include a consideration of processing, for a given time period, all the text-based messages from the venue patron before processing text-based messages from other venue patrons.

45. The method of claim 41 wherein the viewer interaction rules prescribe displaying content requested in the text-based message until another text-based message is received.

46. The method of claim 41 wherein the viewer interaction rules prescribe processing all messages pertaining to a certain type of content before messages of another type of content.

47. The method of claim 41, wherein the viewer interaction rules are updatable by a system administrator.

48. The method of claim 41, further wherein the viewer interaction rules are updatable by a system administrator through a web interface.

49. A method of allowing user interaction with information presented on electronic video displays, the method comprising:
presenting content on at least one display in a venue;
receiving a communication in response to a text-based message, sent from a wireless device, from a venue patron, the text-based message based upon content presented on at least one display in a venue;
responding to the communication with an appropriate action.

50. The method of claim 49, wherein responding to the communication with an appropriate action includes a modification of the content on the at least one display.

51. The method of claim 50, wherein the communication is specific to the at least one display.

52. The method of claim 50, wherein the communication includes content requested by the text-based message.

53. The method of claim 49, wherein responding to the communication with an appropriate action includes creating a memento of content on the at least one display for the venue patron.

54. The method of claim 53, wherein the memento is a printout from a printer located at the venue.

55. The method of claim 49, wherein the communication in response to the text-based message is received from a content management system remote from the venue.

56. The method of claim 49, wherein
the content on the at least one display is presented in accordance with a schedule; and
the communication to the venue modifies the schedule.

57. The method of claim 49, wherein the text-based message is a Short Messaging Service (SMS) message.

58. The method of claim 49, wherein the text-based message is a wireless email.

59. The method of claim 49, wherein the text-based message includes a venue key that is displayed on the at least one display in the venue, the venue key changing based on an algorithm that uses a time of day and location of the venue to create the venue key.

60. The method of claim 49, further comprising:
notifying the venue patron of a position in a queue for processing of the text-based message.

61. The method of claim 60, wherein the notification occurs on the at least one display in the venue.

62. A system for allowing user interaction with information presented on electronic video displays, the system comprising:
a content management system operable to:
provide content for presentation on at least one display in a venue;
receive, from a venue patron, a text-based message from a wireless device, the text-based message based upon the content presented on at least one display in the venue;
process the text-based message; and
transmit a communication to the venue in response to the text-based message.

63. The system of claim 62, wherein the communication to the venue modifies the content on the at least one display.

64. The system of claim 63, wherein the communication is specific to the at least one display.

65. The system of claim 63, wherein the communication includes content requested by the text-based message.

66. The system of claim 62, wherein the communication to the venue creates a memento of content on the at least one display for the venue patron.

67. The system of claim 66, wherein the memento is a printout from a printer located at the venue.

68. The system of claim 66, wherein
the communication is a memento message to the wireless device with the memento, and
the memento is stored in memory on the wireless device.

69. The system of claim 62, wherein the content management system is located remotely from the venue.

70. The system of claim 62, wherein at least a portion of the content management system is located at the venue.

71. The system of claim 62, wherein
the content on the at least one display is presented in accordance with a schedule; and
the communication to the venue modifies the schedule.

72. The system of claim 62, wherein the text-based message is a Short Messaging Service (SMS) message.

73. The system of claim 62, wherein the text-based message is a wireless email.

74. The system of claim 62, wherein the text-based message includes a code specific to the at least one display.

75. The system of claim 74, wherein the code distinguishes the at least one display from other displays.

76. The system of claim 62, wherein the text-based message includes a venue key that is displayed on the at least one display in the venue, the venue key changing over time.

77. The system of claim 76, wherein the venue key changes over time based on an algorithm that uses a time of day and location of the venue to create the venue key.

78. The system of claim 62, wherein the content management system is further operable to:
receive, from one or more venue patrons, a plurality of text-based messages from one or more wireless devices; and
process each of the plurality of text-based messages;
record information obtained from the processing; and
report the information via an interface to a user.

79. The system of claim 78, wherein the interface is presented in a dashboard format and accessible via a web browser.

80. The system of claim 78, wherein the information includes a number of viewers that request certain types of content.

81. The system of claim 62, wherein the content management system is further operable to:
notify the venue patron of a position in a queue for processing of the text-based message.

82. The system of claim 81, wherein the notification occurs on the at least one display in the venue.

83. The system of claim 81, wherein the notification is sent to the wireless device.

84. The system of claim 62, wherein the content management system in processing the text-based message validates contents of the text-based message, and if the text-based message is successfully validated, executes logic applicable to a request in the text-based message.

85. The system of claim 62, wherein the content management system in processing the text-based message compares a transaction code in the text-based message against a schedule currently running for the at least one display in the venue, and if the transaction code is allowed, modifies the schedule.

86. The system of claim 1, wherein the content management system in processing prepares a solicitation of additional information from the venue patron, wherein the solicitation is transmitted to the wireless device.

87. The system of claim 1, wherein the content management system processes a plurality of text based message in accordance with viewer interaction rules.

88. The system of claim 25, wherein the viewer interaction rules include a consideration of processing the text-based messages in the order the text-based messages are received.

89. The system of claim 25, wherein the viewer interaction rules include a consideration of processing the most requested content first.

90. The system of claim 25, wherein the viewer interaction rules include a consideration of processing, for a given time period, all the text-based messages from the venue patron before processing text-based messages from other venue patrons.

91. The system of claim 25, wherein the viewer interaction rules prescribe displaying content requested in the text-based message until another text-based message is received.

92. The system of claim 25, wherein the viewer interaction rules are updatable by a system administrator.

93. The system of claim 25, wherein the viewer interaction rules are updatable by a system administrator through a web interface.
